(19) United States
(12) Patent Application Publication
(10) Pub. No.: US 2017/0200201 A1
(43) Pub. Date: Jul. 13, 2017

(54) CONVERSATION TO COMMERCE

(71) Applicant: RE:SOURCES USA, Boston, MA (US)

(72) Inventors: Erin Lanuti, New York, NY (US); Benoit Bignon, New York, NY (US); Will Parker, New York, NY (US); Sebastian Shapiro, New York, NY (US); Monty Kiernan, New York, NY (US); David Dixon, New York, NY (US); Julia Soukhareva, New York, NY (US); Guillaume Guay, New York, NY (US)

(21) Appl. No.: 15/406,341

(22) Filed: Jan. 13, 2017

Related U.S. Application Data
(60) Provisional application No. 62/278,399, filed on Jan. 13, 2016.

(51) Int. Cl. G06Q 30/02

(52) U.S. Cl. CPC G06Q 30/0269; G06Q 30/0277

(57) ABSTRACT

A computer-implemented method may provide a dashboard configured to monitor postings from users and process user postings placed on the dashboard for earned content. The method may then select earned content from the dashboard and generate an advertising unit comprising the selected earned content. The generated advertising unit may then be distributed in a targeted fashion to at least one user.

### CROSS-REFERENCE TO RELATED APPLICATION

This application claims the benefit of U.S. Provisional Application No. 62/278,399 entitled “CONVERSATION TO COMMERCE” filed Jan. 13, 2016, the disclosure of which is entirely incorporated herein by reference.

### BACKGROUND

Description of Related Art

Existing systems do not permit companies to properly leverage earned content.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 depicts a flow diagram of a method in accordance with example embodiments.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

Earned media may be a driver of purchase intent, consideration and familiarity (e.g., Nielsen) but conventional solutions lack scale and the ability to tie earned media to commerce. With the shift in marketing to content marketing, the example embodiments leverage trusted earned media content in a meaningful way by connecting it to commerce.

The example embodiments accomplishes this and other things. First, the example embodiments provide scale to earned content. Second, the example embodiments target relevant earned content to people who are exhibiting a behavioral interest. For example, someone searching on Google for “best television” could be programmatically served an article for “Consumer Reports: Top rated television.” This may be considered a paradigm shift as earned media has used a publication as a proxy for the target and now the example embodiments may programmatically target relevant articles to a target at the moment of need. Third, the example embodiments may elongate earned media's lifespan. For example, an article in today's New York Times on top health trends of 2016 may be relevant all year and can be leveraged all year in the model described herein by driving to that placement. Fourth, the example embodiments may use universal measurement standards to measure the impact of content units on commerce instead of the typical earned media metrics.

The example embodiments may take earned content (e.g., live earned content), convert the earned content (e.g., instantly or in real-time) into programmatic display units that may come in a variety of sizes (e.g., top IAB Sizes—300×250, 300×600, video, Facebook newsfeed, mobile and many other formats). The example embodiments may also create advertisements in multiple different languages (e.g., English, Chinese, French and Spanish). Further, the example embodiments may provide for re-messaging a target after an initial advertisement is served to drive the target person to commerce.

In further instances, the example embodiments may connect earned media to commerce in any market around the world, convert earned content into a content unit that can be served to a targeted person in need of information as determined by behavioral targeting, and attribute earned media to brand and sales lift.

Appendices A and B depict various example embodiments of conversation to commerce.

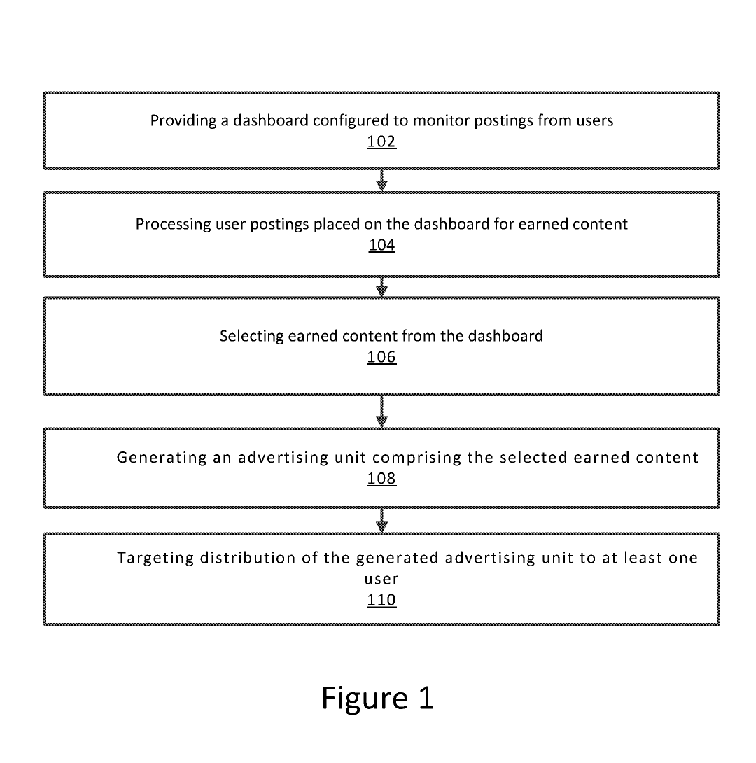

FIG. 1 depicts a flow diagram of a conversation to commerce method in accordance with example embodiments. The flow diagram may be implemented by a system, computer, apparatus, device, and any combination thereof. Each of the blocks shown in the flow diagram may be repeated one or more times, one or more of the blocks may be modified, and one or more of the blocks may be omitted. The method may be stored on a non-transitory computer readable medium as computer executable instructions. The computer executable instructions, when executed by at least one processor, may cause at least one computer or other device to perform the blocks as steps of a method one or more times.

The example embodiments may provide benefits over conventional solutions. For example, conventional solutions may be considered earned amplification tools. Such tools are native advertisements served as “recommended content” in the content well of a publisher's site. These tools do not provide satisfactory control over where ads are served, and instead only provide targeting based on contextual and demographic data. Further, retargeting options in conventional solutions are exceptionally limited and only available if you drive to your website.

Moreover, the example embodiments may provide technical solutions to technical problems. The example embodiments may identify timely, relevant earned content quickly and efficiently (e.g., via a Dashboard). The example embodiments may also quickly and efficiently convert earned content into an ad unit (e.g., using EPI Software). For example, the example embodiments may apply programmatic targeting to target the ad unit to a particular person. For example, the ad unit may be targeted to an appropriate person. The example embodiments may tie the ad unit to commence. The example embodiments may also monitor brand lift, e-Commerce, offline sales lift, customer relationship management (CRM), provide Mobile/Location-based data, obtain data that ties earned content to brand and sales lift in advance of, during, and/or after a campaign launch, and generate a credible index leveraging conversation to commerce (C2C) data to build an index of the top publications/influencers that deliver brand/sales lift in a category.

The example embodiments may provide a number of novel features. First, the example embodiments may quickly and seamlessly take an instance of earned media and convert it into a programmatic display content unit. Second, the example embodiments may target earned content quickly to an appropriate person based on behavior and search intent and other programmatic targeting parameters. Third, the example embodiments may re-message initial earned content with a brand ad offer to tie to commerce. Fourth, the example embodiments may tie earned media in this format to commerce. Fifth, the example embodiments may provide for pretesting earned content and showing brand and sales lift

The example embodiments may be implemented on computers and servers such as, for example, general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The computers and servers may be running on any one of many operating systems including, but not limited to WINDOWS, UNIX, LINUX, MAC OS, or Windows (XP, VISTA, etc.). It is contemplated, however, that any suitable operating system may be used for the present invention. The computers and servers may be a cluster of web servers, which may each be LINUX based and supported by a load balancer that decides which of the cluster of web servers should process a request based upon the current request-load of the available server(s).

The computers and servers may be connected via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system 100 are examples. Any device may communicate with any other device via one or more networks.

The example embodiments may include additional devices and networks beyond those disclosed. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, systems and methods described herein may be configured for converting conversation to commerce. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed:

1. A computer-implemented method comprising:
providing a dashboard configured to monitor postings from users;
processing user postings placed on the dashboard for earned content;
selecting earned content from the dashboard;
generating an advertising unit comprising the selected earned content; and
targeting distribution of the generated advertising unit to at least one user.
